(19) United States
(12) Patent Application Publication
(10) Pub. No.: US 2013/0316299 A1
(43) Pub. Date: Nov. 28, 2013

(54) AIR/WATER DENTAL SYRINGE TIP ADAPTER SYSTEMS AND CONVERSION METHODS

(71) Applicant: Donovan Berkely, Irvine, CA (US)

(72) Inventor: Donovan Berkely, Irvine, CA (US)

(21) Appl. No.: 13/841,280

(22) Filed: Mar. 15, 2013

Related U.S. Application Data
(60) Provisional application No. 61/619,578, filed on Apr. 3, 2012.

(51) Int. Cl. A61C 17/02

(52) U.S. Cl. CPC A61C 17/02
USPC 433/80; 433/215

(57) ABSTRACT

Conversion assemblies enable an air/water dental syringe adapted for connection to an existing tip such as an autoclavable tip to instead receive disposable tip. A conversion kit includes a cap subassembly with a cap body having a distal opening into which the disposable tip is inserted, and an adapter subassembly having a proximal end configured for connection to the syringe body and a distal end configured for coupling to the cap subassembly. The adapter subassembly includes one or more components with cut-outs, grooves or channels to direct air and water from the syringe body to the air-carrying channels and water-carrying tube of the disposable tip through the cap subassembly. To accommodate a wide variety of syringe styles, the adapter subassembly may include a proximal receptacle to receive a stem on the syringe; a proximal stem insertable into the syringe; one or more proximal air- or water-carrying tubes insertable into the syringe; or a threaded connection to the syringe body.

### REFERENCE TO RELATED APPLICATION

This application claims priority from U.S. Provisional Patent Application Ser. No. 61/619.578, filed Apr. 3, 2012, the entire content of which is incorporated herein by reference.

### FIELD OF THE INVENTION

This invention relates generally to air/water syringes and, in particular, to adapter units that enable replaceable, disposable tips to be used with various handle assemblies including European style syringes.

### BACKGROUND OF THE INVENTION

Dental syringes are hand-held instruments which deliver water and air under pressure into a patient's mouth for washing and drying purposes. Such instruments are widely used by dentists, orthodontists, oral surgeons, dental hygienists and dental assistants. A typical dental includes a head unit which is coupled to hoses that supply water at about 40 PSI and air at about 80 PSI. An elongated tip coupled to the head unit is inserted into a patient's mouth, and buttons on the head unit are operated to discharge water or air through the distal end of the tip.

Cross contamination is one of the principal problems encountered with dental syringes. Bacteria and viruses can be communicated from patient to patient unless the syringe tip is adequately sanitized. The safest and most desirable approach is to replace the syringe tip from the head after each patient treatment. In addition, it is desirable to be able to replace worn tips or change to tips of different configurations quickly and easily.

Several decades ago, dental syringe tips were not readily removable from the syringe head units. Removal often necessitated the unscrewing of a coupling from the head and the sliding of the coupling off of the tip. Around this time, the tip once removed and the associated coupling were autoclaved. A number of small elastomeric O-rings had to be removed before autoclaving because they could not withstand the heat and pressure of the autoclaving process. The entire process was a time consuming, often frustrating experience.

Around 1980, dental syringe quick-disconnect tips were invented. U.S. Pat. No. 4,248,589, the entire content of which is incorporated herein by reference, discloses a dental syringe that includes a head 10, a coupling 12, and a removable, replaceable tip 14 (FIG. 1). The head 10 has internal water and air passages 16 and 18 in communication with an internally threaded cylindrical cavity 22 in the top frontal surface of the head (FIG. 2). The head and tip include a corresponding number of fluid passages. The coupling 12 includes a cylindrical base and a lock nut which screws over the base. The base and the lock nut define an axially extending bore which communicates with the passages through the head and removably receives the rearward portion of the tip 14. An elastomeric O-ring is positioned between the base and the lock nut and surrounds the bore. When the rearward portion of the tip is fully inserted in the bore the O-ring seats in a groove surrounding the rearward portion of the tip. When the lock nut is fully screwed over the base, deformation of the O-ring is substantially prevented and the tip cannot be withdrawn or ejected from the coupling.

The tip 14 comprises inner and outer elongate, coaxial, spaced apart pipes 36 and 38 which define water and air passages 40 and 42, respectively. The forward portions of the pipes are angled with respect to the rearward portions. The forward end 44 of the inner pipe 36 is open and the forward end 46 of the outer pipe 38 is bent inwardly and is sealed to the inner pipe 36. The forward end 46 has a plurality of annularly spaced nozzle apertures such as 48.

The rearward portion 50 of the outer pipe 38 terminates short of the rearward portion 52 of the inner pipe 36 and is bent inwardly and sealed to the rearward portion 52. The rearward end 53 of the inner pipe 36 is open and coaxial with the water passage 16 and abuts the bottom of the cavity 22 when inserted in the coupling 12. The periphery of the rearward portion 50 is formed with a pair of axially spaced, rearward and forward annular grooves 54 and 56. A pair of diametrically positioned inlet apertures 58 and 60 extend through the wall of the outer pipe 38 in the groove 54, as shown in FIG. 3.

Ducts 82 and 84 in the base 62 extend from the bore 72 in the base to a chamber 80. When the rearward portion of the tip is fully inserted in the bore 72, air can flow from the air passage 18 into the chamber 80, through the ducts 82 and 84, into the bore 72, through the apertures 58 and 60, into the air passage 42 and through the tip.

Push buttons 24 and 26 on the top rear surface of the head are coupled to normally closed valves and are selectively hand-operated to discharge water, air, or both through the distal end 28 of the tip 14. A handle 30 can be threaded with the shank 20 to connect water and air supply hoses 32 and 34 to the water and air passages 16 and 18, respectively. When the push buttons 24 and 26 are simultaneously depressed water spray mist is produced.

Since the development of the quick-release syringe tip system just described several improvements have taken place. Central to such improvements is the development of the disposable tip which is retrofittable to the older metal units which must be autoclaved to reuse. Disposable air/water syringe tips resemble bent, plastic straws with multiple cannulations to receive and deliver air and water from existing hand-held units. One leading manufacturer is Crystal. Tip of Irvine, Calif.

As with the earlier, autoclavable metal syringe tips, the proximal end of the Crystal Tip includes a central, protruding tube to receive water which, like its predecessors, seals against an O-ring in the syringe body. However, as shown in FIG. 4, the tip does not have proximal side ducts through which the air flows; rather the proximal end surrounding the water tube does not ‘bottom out’ within the syringe body, allowing air to enter the cannulations surrounding the central water tube. Crystal Tips are designed to be used directly on common U.S. and Canadian syringes. In particular, Crystal Tips fit syringes from Adec (Newberg, Oreg.), DCI International (Newberg, Oreg.) and Unic/Heka (Ishoj, Denmark) without the need for any so-called adapter units.

Currently in Europe, however, most syringes use autoclavable tips. As a result, there has been little attempt to upgrade to new standards that have been in place for years. As such, disposable tips, including Crystal Tips, cannot be used directly on any European syringe. Syringes with autoclavable tips use a variety of routing patterns to deliver air and water to the tip. However, all U.S. disposable tips receive their air flow through the base of the tip that is inserted into the syringe. Autoclavable tips route air flow through a side port (hole) directly below an O-ring grove on the metal tip. As such, without some type of conversion, disposable tips are incompatible with European-style syringes that use autoclavable tips.

Given that there are numerous proprietary designs outside North America, it would be advantageous to provide these syringes with appropriate adapter kits enabling them to utilize standard, disposable quick-release air/water tips.

### SUMMARY OF THE INVENTION

This invention resides in conversion assemblies enabling a disposable tip to connect to an existing dental syringe configured to receive a different type of tip such as an autoclavable tip. The tip has proximal and distal ends with a central, water-carrying tube surrounded by air-carrying channels. The tip, typically constructed from extruded or molded plastic, may be straight or bent, and may have flat flush ends or a water tube that extends outwardly from the proximal end.

A conversion kit enabling an air/water syringe body to receive a disposable tip includes a cap subassembly with a cap body having a distal opening into which the proximal end of the elongated disposable tip is inserted, and an adapter subassembly having a proximal end configured for connection to the syringe body and a distal end configured for coupling to the cap subassembly. The adapter subassembly includes one or more components with cut-outs, grooves or channels to direct air and water from the syringe body to the air-carrying channels and water-carrying tube of the disposable tip through the cap subassembly.

To accommodate a wide variety of syringe styles, the adapter subassembly may include a proximal receptacle to receive a stem on the syringe body; a proximal stem insertable into the syringe body; one or more proximal air- or water-carrying tubes insertable into the syringe body; or a threaded connection to the syringe body.

The preferred embodiment further includes a cup-shaped ferrule to receive the proximal end of the disposable tip once inserted into the cap subassembly. Such a ferrule may include a central opening through which water passes into the water-carrying tube of the disposable tip and one or more side cut-outs through which air passes into the air-carrying channels of the disposable tip. The ferrule may further include a central opening to receive a water-carrying tube extending from the proximal end of the disposable tip. A threaded or quick-disconnect connection may be provided between the cap and adapter subassemblies. The cap and adapter subassemblies are preferably autoclavable in the absence of the disposable tip.

A method enabling a dental syringe having an existing tip to instead receive a disposable tip having a central, water-carrying tube surrounded by a plurality of air-carrying channels, comprises the steps of: removing the existing tip from the syringe; coupling conversion assembly to the syringe, the assembly having proximal end adapted for connection to the syringe in place of the existing tip, and a distal end with an opening to receive the proximal end of a disposable tip, the conversion unit including an internal structure with a first path for coupling the water port of the syringe to the water-carrying tube of the tip and a second path for coupling the air port of the syringe to the air-carrying channels of the tip; and inserting the proximal end of the tip into the distal end of the adapter such that water is able to flow from the syringe through the water-carrying tube of the disposable tip, and air from the syringe is able to flow from the syringe through the air-carrying channels of the disposable tip.

### BRIEF DESCRIPTION OF THE DRAWINGS

FIG. 1 is an exploded isometric view of a prior art dental syringe showing its quick-release tip withdrawn;

FIG. 2 is an enlarged side elevational view of the dental syringe of FIG. 1 with portions broken away;

FIG. 3 is a sectional view taken along line 3-3 of FIG. 2;

FIG. 4 is a drawing in partial cross section showing an adapter body and disposable tip applicable to the invention;

FIG. 5 is a side view of a typical ferrule constructed in accordance with the invention, showing side grooves configured for the passage of air;

FIG. 6 is an exploded view illustrating how the invention replaces an autoclavable tip on a generic, European-style with a conversion kit and disposable tip;

FIG. 7 is a cross section of a quick-release version of the threaded adapter body of FIG. 4;

FIGS. 8A-8G illustrate syringe systems to which the invention is applicable that feature stems protruding from the syringe body;

FIGS. 9A-9C illustrate syringe systems to which the invention is applicable that feature threaded connections between the syringe body and the tip which is removed;

FIGS. 10A-10F illustrate syringe systems to which the invention is applicable that feature stems protruding from the removed tip and into the syringe body;

FIGS. 11A-11D illustrate syringe systems to which the invention is applicable that feature tube projections from the removed tip and into the syringe body;

FIG. 12 is a cross section of a Castellini syringe body and a conversion kit enabling the syringe to accept disposable tips;

FIG. 13 is a cross section of a Cefla F3 LUZ syringe body and a conversion kit enabling the syringe to accept disposable tips;

FIG. 14 is a cross section of a Cefla F6 Anthos syringe body and a conversion kit enabling the syringe to accept disposable tips;

FIG. 15 is a cross section of a Chirana syringe body and a conversion kit enabling the syringe to accept disposable tips;

FIG. 16 is a cross section of a Faro SM03 syringe body and a conversion kit enabling the syringe to accept disposable tips;

FIG. 17 is a cross section of a Faro SYR syringe body and a conversion kit enabling the syringe to accept disposable tips;

FIG. 18 is a cross section of a Kayo 1056 syringe body and a conversion kit enabling the syringe to accept disposable tips;

FIG. 19 is a cross section of a Kayo 1056S syringe body and a conversion kit enabling the syringe to accept disposable tips;

FIG. 20 is a cross section of a Kayo 6F syringe body and a conversion kit enabling the syringe to accept disposable tips;

FIG. 21 is a cross section of a Kayo Systematica (with light) syringe body and a conversion kit enabling the syringe to accept disposable tips;

FIG. 22 is a cross section of a Kayo Systematica (without light) syringe body and a conversion kit enabling the syringe to accept disposable tips;

FIG. 23 is a cross section of a Kayo K4 syringe body and a conversion kit enabling the syringe to accept disposable tips;

FIG. 24 is a cross section of a Kayo Esthetica syringe body and a conversion kit enabling the syringe to accept disposable tips;

FIG. 25 is a cross section of a Sirona 4000 syringe body and a conversion kit enabling the syringe to accept disposable tips;

FIG. 26 is a cross section of a Sirona C8 Teneo syringe body and a conversion kit enabling the syringe to accept disposable tips;

FIG. 27 is a cross section of a Ritter Topjet syringe body and a conversion kit enabling the syringe to accept disposable tips;

FIG. 28 is a cross section of a Luzzani Mini Assistant syringe body and a conversion kit enabling the syringe to accept disposable tips;

FIG. 29 is a cross section of a Luzzani Mini Mate syringe body and a conversion kit enabling the syringe to accept disposable tips;

FIG. 30 is a cross section of a Luzzani Mini Light syringe body and a conversion kit enabling the syringe to accept disposable tips;

FIG. 31 is a cross section of a Luzzani Mini Brite syringe body and a conversion kit enabling the syringe to accept disposable tips;

FIG. 32 is a cross section of a Morita WS66 syringe body and a conversion kit enabling the syringe to accept disposable tips;

FIG. 33 is a cross section of a Morita WS97 syringe body and a conversion kit enabling the syringe to accept disposable tips;

FIG. 34 is a cross section of a Morita W10 yringe body and a conversion kit enabling the syringe to accept disposable tips;

FIG. 35 is a cross section of a Morita WS12 syringe body and a conversion kit enabling the syringe to accept disposable tips;

FIG. 36 is an exploded view of a Takara Belmont syringe body and a conversion kit enabling the syringe to accept disposable tips;

FIG. 37 is a cross section of an Osada MSF syringe body and a conversion kit enabling the syringe to accept disposable tips; and

FIG. 38 is a cross section of a Tridac syringe body and a conversion kit enabling the syringe to accept disposable tips.

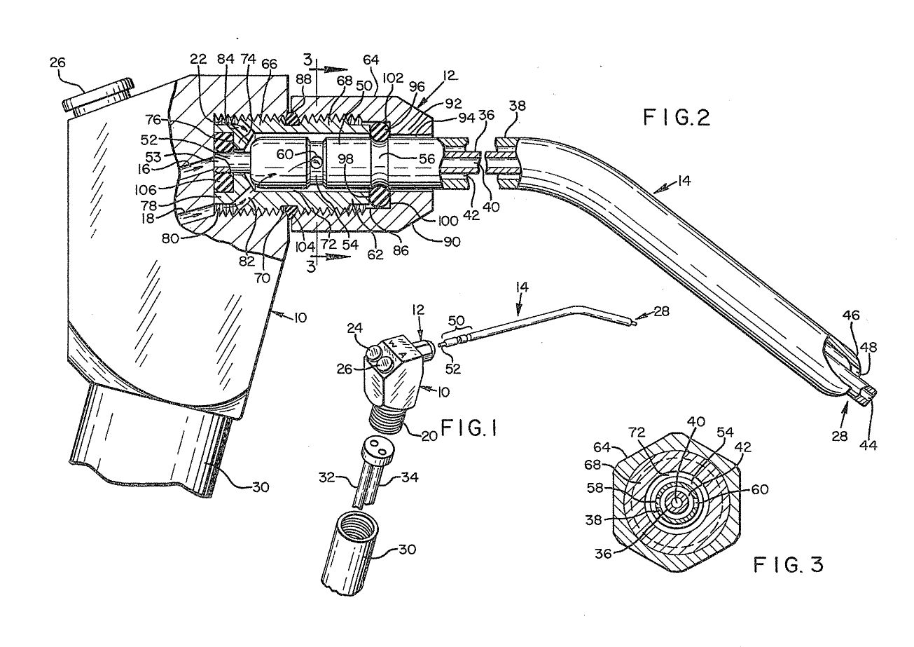

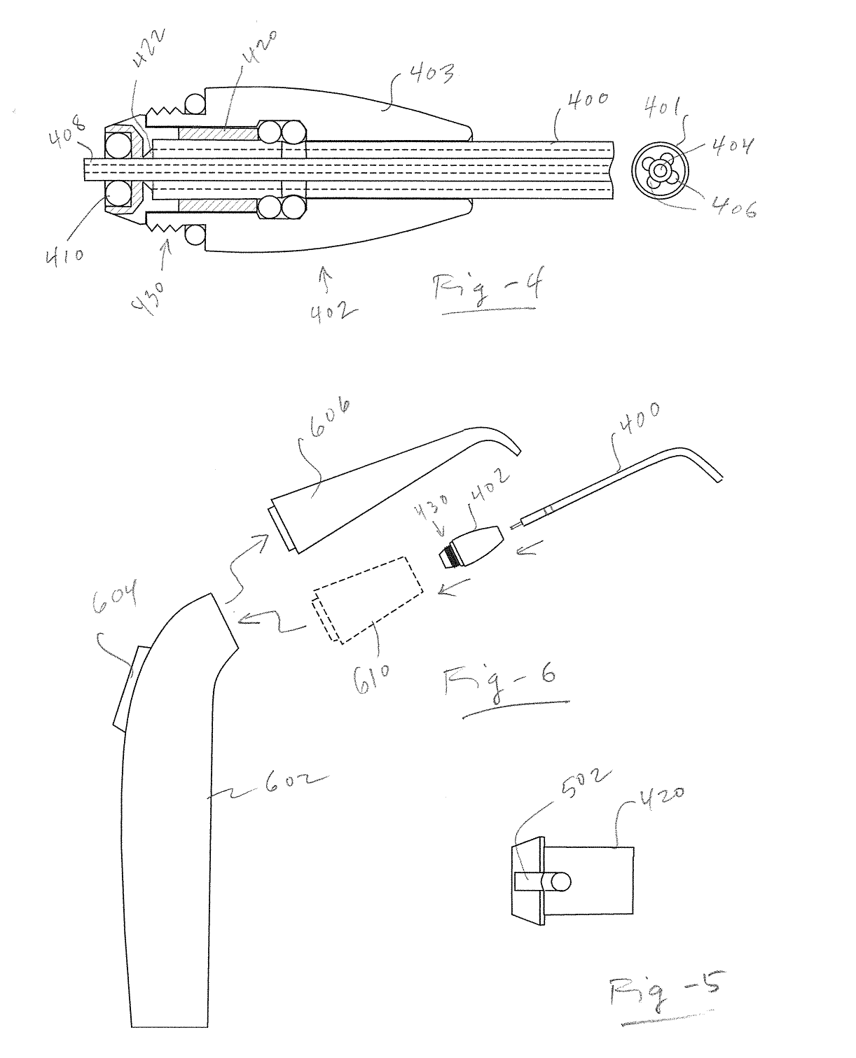

### DETAILED DESCRIPTION OF THE INVENTION

This invention improves upon existing air/water syringe instrumentation by providing adapter units that enable replaceable, disposable tips to be used with various syringe assemblies, including European-style syringes. To accomplish this goal, the invention provides two subassemblies; first, a cap subassembly that receives the disposable tip, and an adapter subassembly that couples the cap with the tip to the syringe body after the non-disposable or autoclavable tip has been removed.

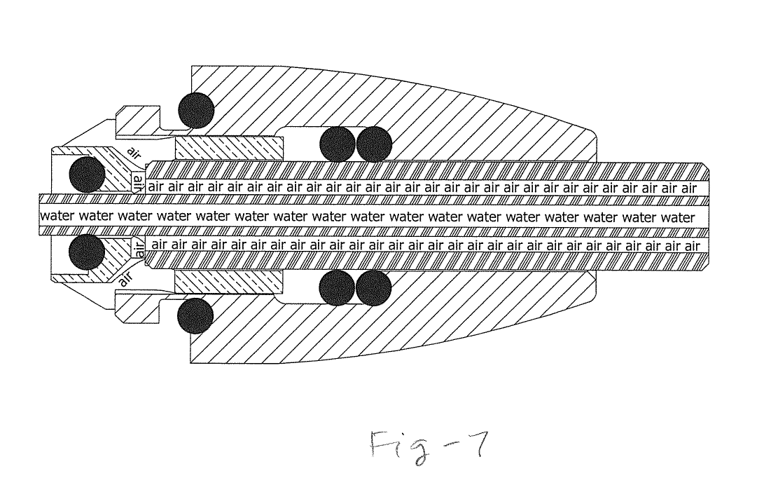

FIG. 4 is a drawing in partial cross section which illustrates a cap subassembly applicable to the invention. The disposable tip is shown at 400, and 401 is and end view showing the central water-carrying tube 404 surrounded by air-carrying channels 406. In the tip shown, a Crystal Tip from Westside Resources of Irvine, Calif., the water tube protrudes form the proximal end of the tip at 408, facilitating an additional O-ring seal at 410 for enhanced air/water separation. However, the invention is also applicable to disposable tips with flush air/water passages opposing flat proximal and distal ends. Nor is the invention limited in terms of the number of air-carrying channels surrounding the central water-carrying tube.

Continuing the reference to FIG. 4, the cap subassembly 402 includes an outer body 403 with a distal end to receive the tip 400 and a proximal end configured to receive a ferrule 420. The ferrule includes a cup-shaped receptacle that receives the proximal end of the disposable tip once inserted into the cap body 403. In the configuration shown, the proximal end of the tip includes a tapered region to ensure that the tip end does not “bottom out” against the bottom of the ferrule cup. This allows air to flow through side grooves 502 shown in FIG. 5 and into the air-carrying channels 406 of the tip. Again, however, as long as access to the air-carrying channels is provided, such a tapered region is not necessarily required.

FIG. 6 is a simplified drawing showing a generic syringe body 602 with air/water control buttons 604. The figure also shows a generic autoclavable tip 606 which is removed from the body 602 and replaced with a cap body 402 receiving disposable tip 400. A generic adapter subassembly is shown at 610 which not only couples the cap subassembly to the syringe body, but also includes appropriate passageways necessary to ensure that air and water supplied by the syringe find their ways to the respective air and water channels of the disposable tip. Note that the cap subassembly may include a threaded connector 430 or, alternatively, may utilize a quick release connection of the type depicted in FIG. 7. FIG. 7 also illustrates air and water flow which would be the same in FIG. 4.

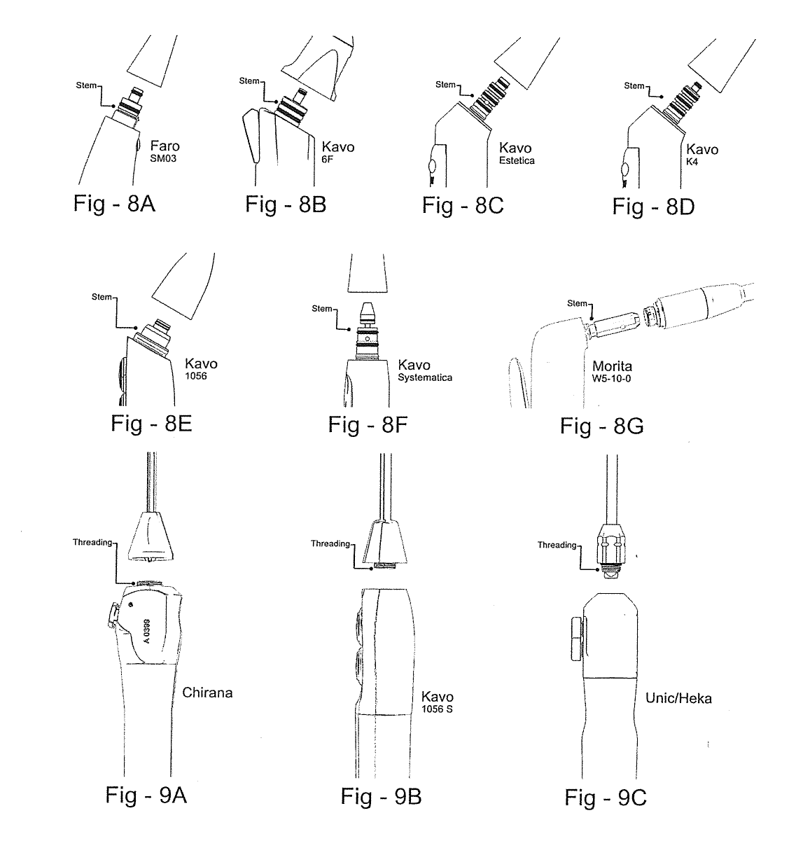

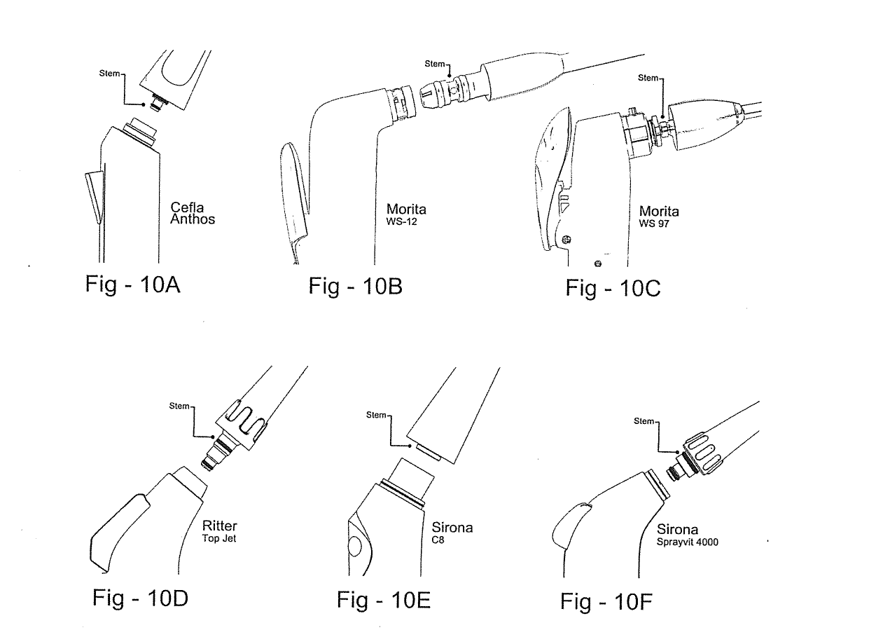

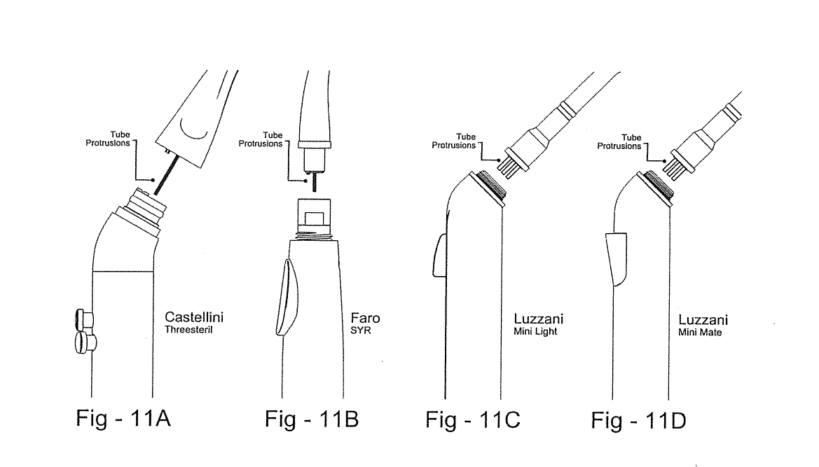

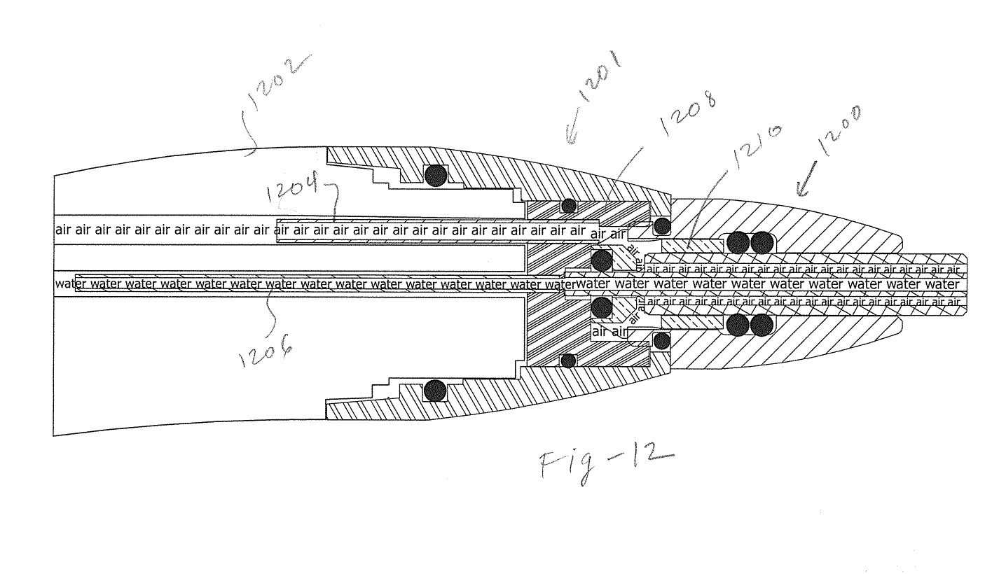

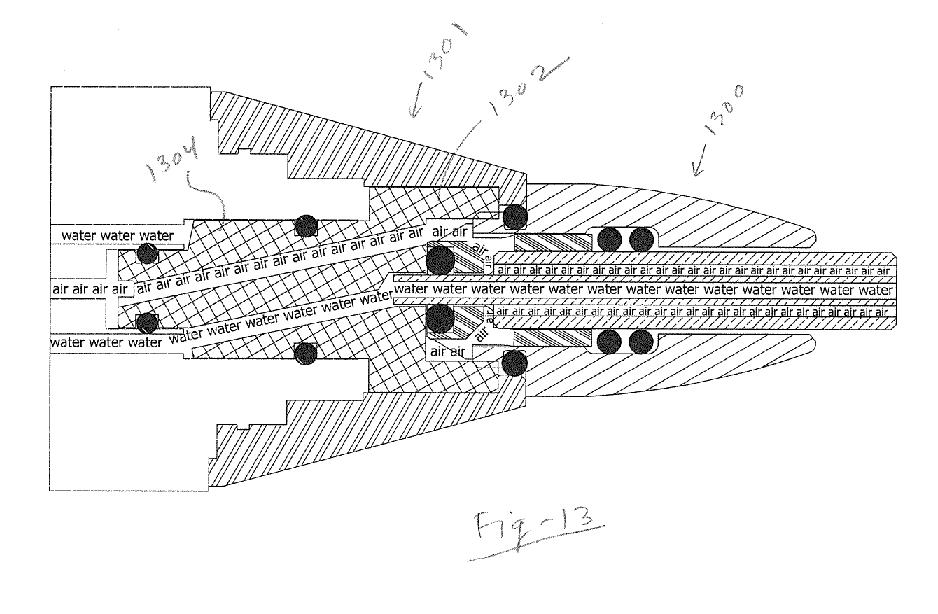

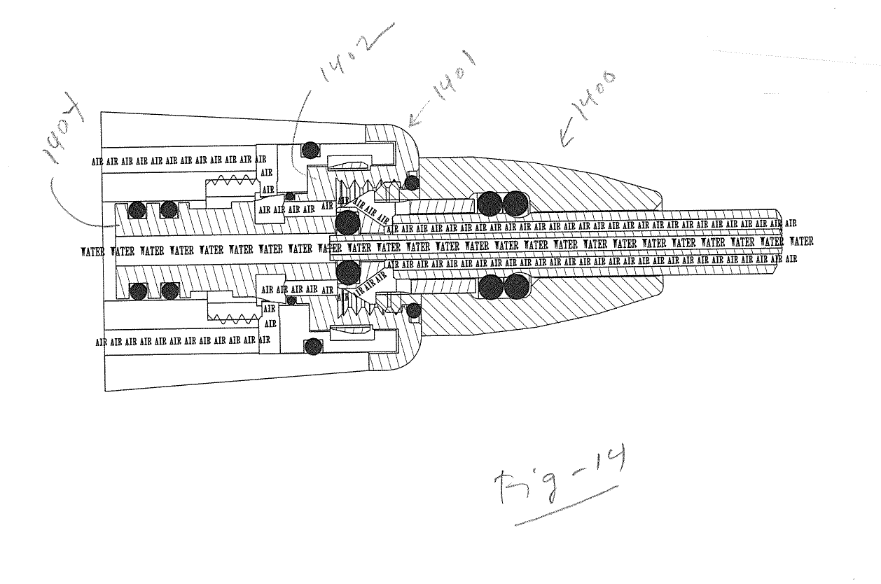

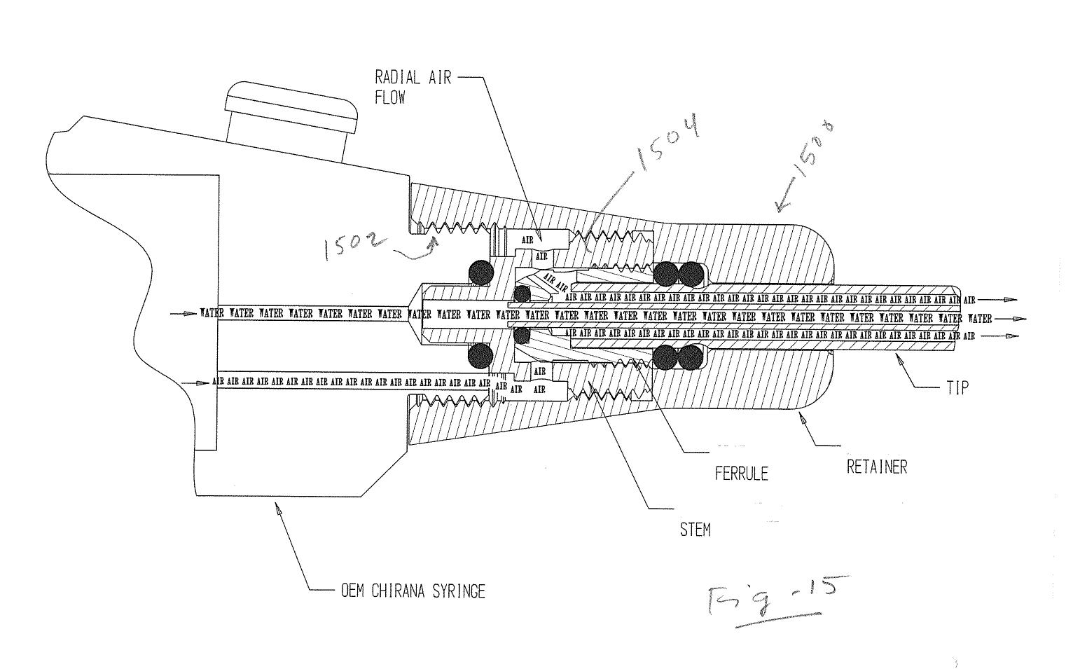

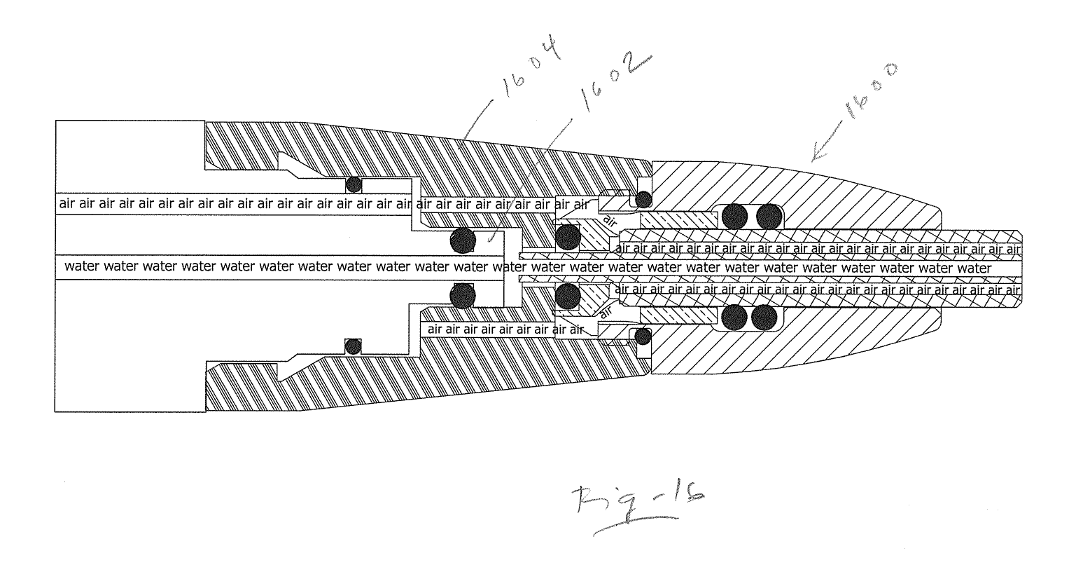

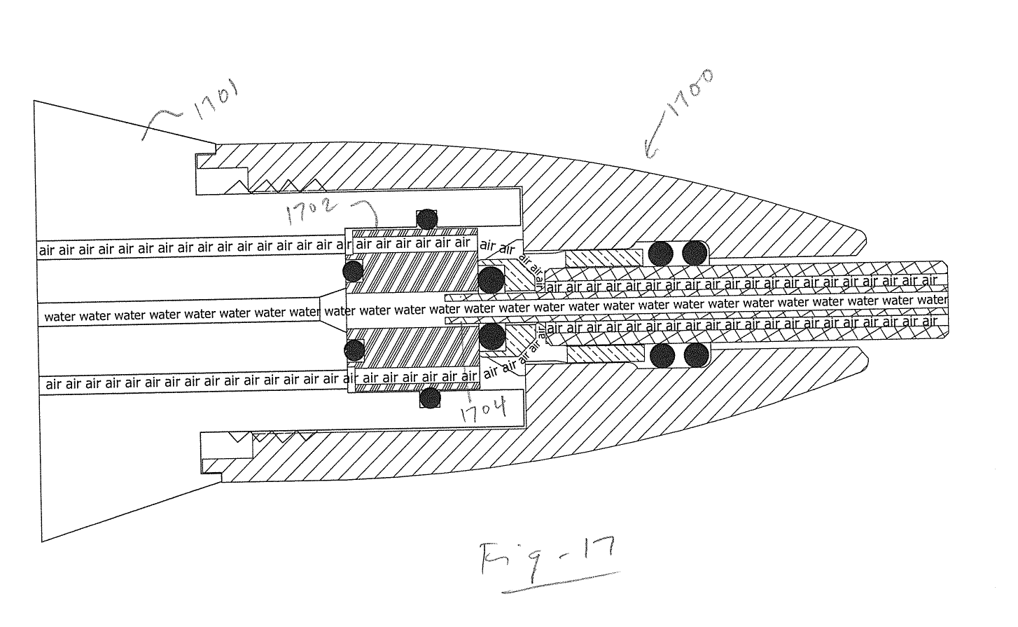

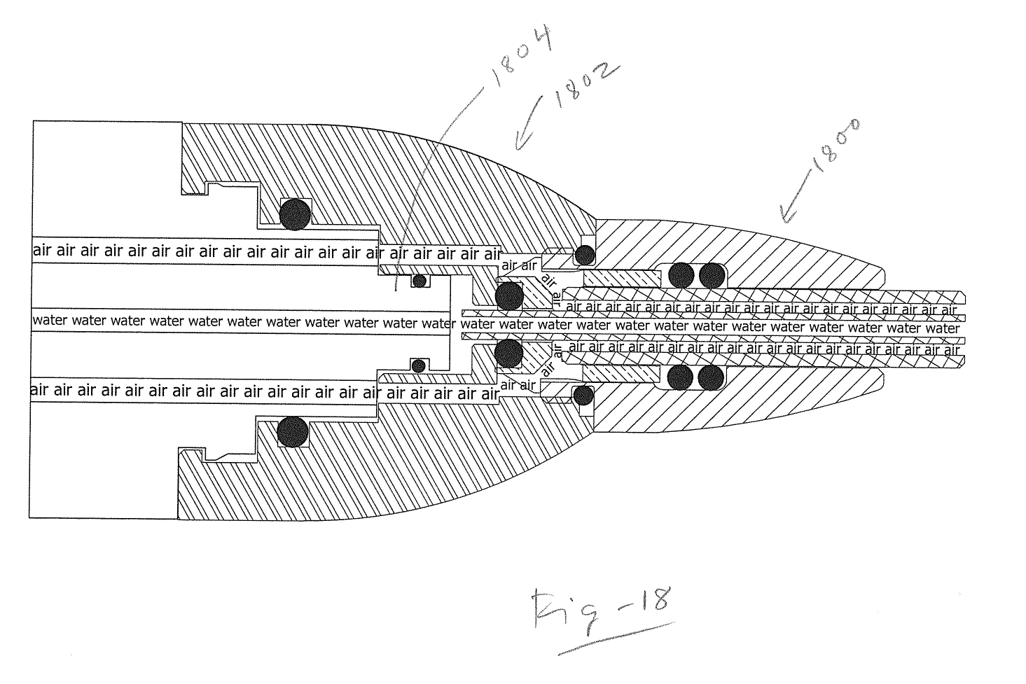

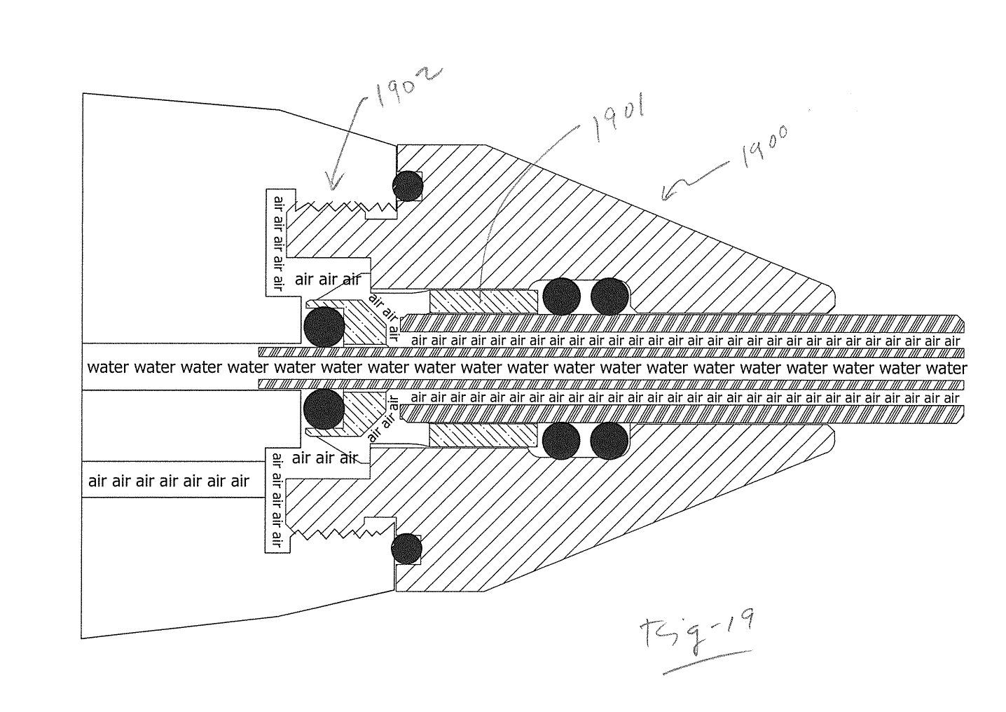

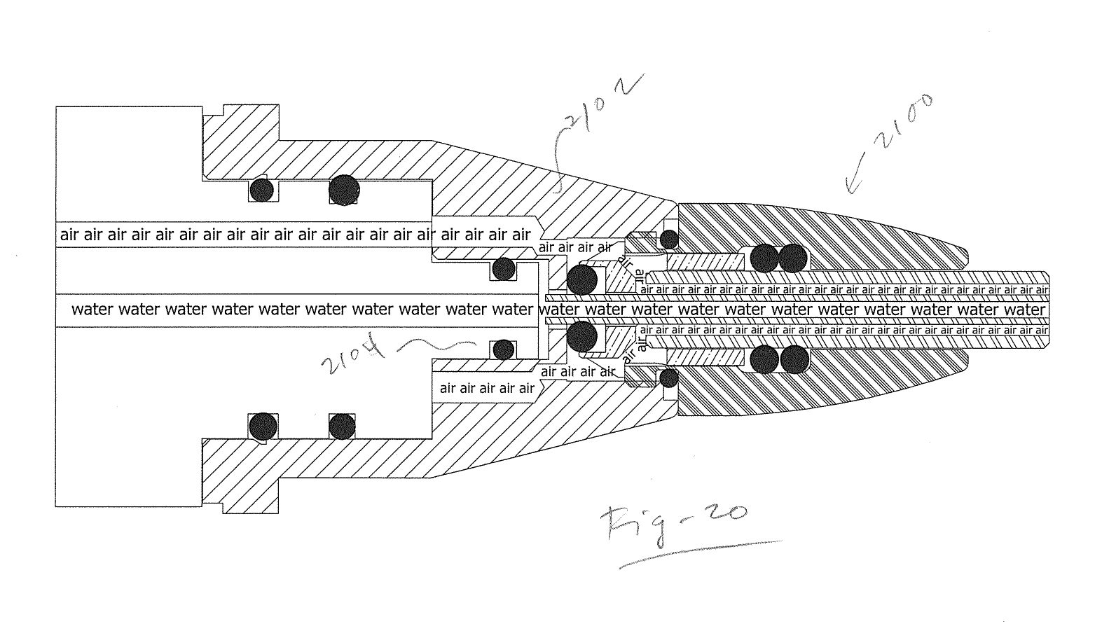

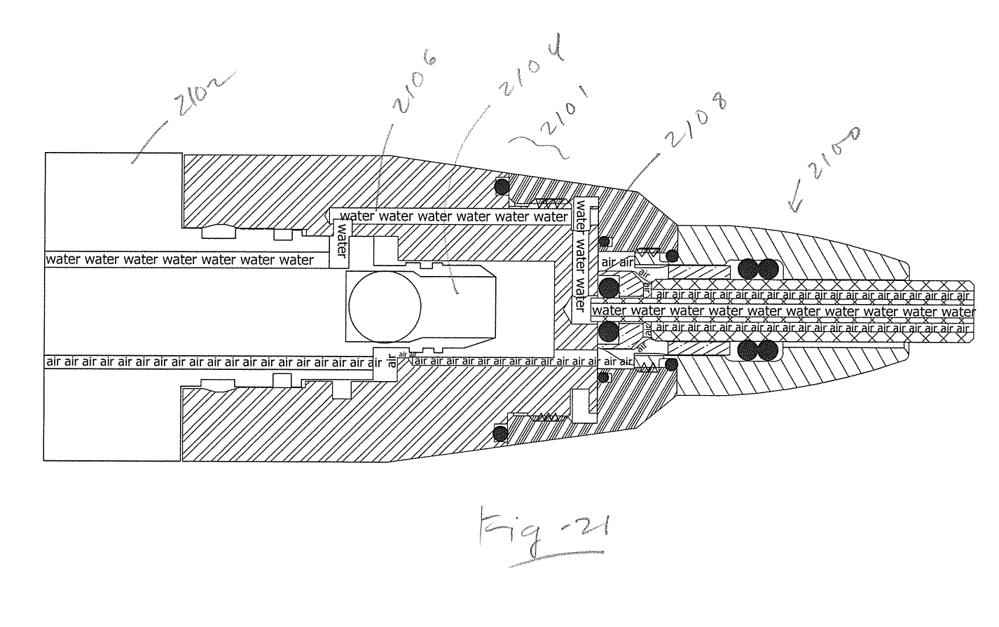

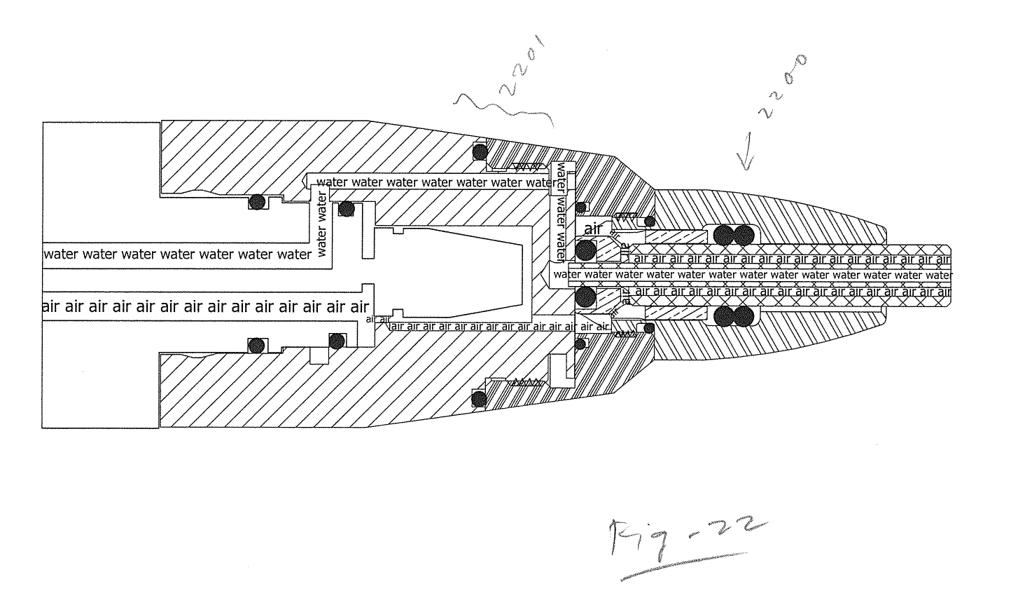

The adapter subassemblies of the invention span a range of parts and complexity depending upon the type of syringe and the tip being replaced. That said, the invention accommodates all current styles and may be extended to yet-to-be developed designs with appropriate engineering modification. In particular, the invention includes adapter subassemblies to accommodate syringe systems with stems that protrude from the syringe body, as exemplified in FIGS. 8A-8G; syringe systems that feature threaded connections between the syringe body and the tip without any prominent protrusions, as depicted in FIGS. 9A-9C; syringe systems with stems protruding from the removed tip, as shown in FIGS. 10A-10F; and syringe systems that feature tube projections from the removed tip, as shown in FIGS. 11A-11D.

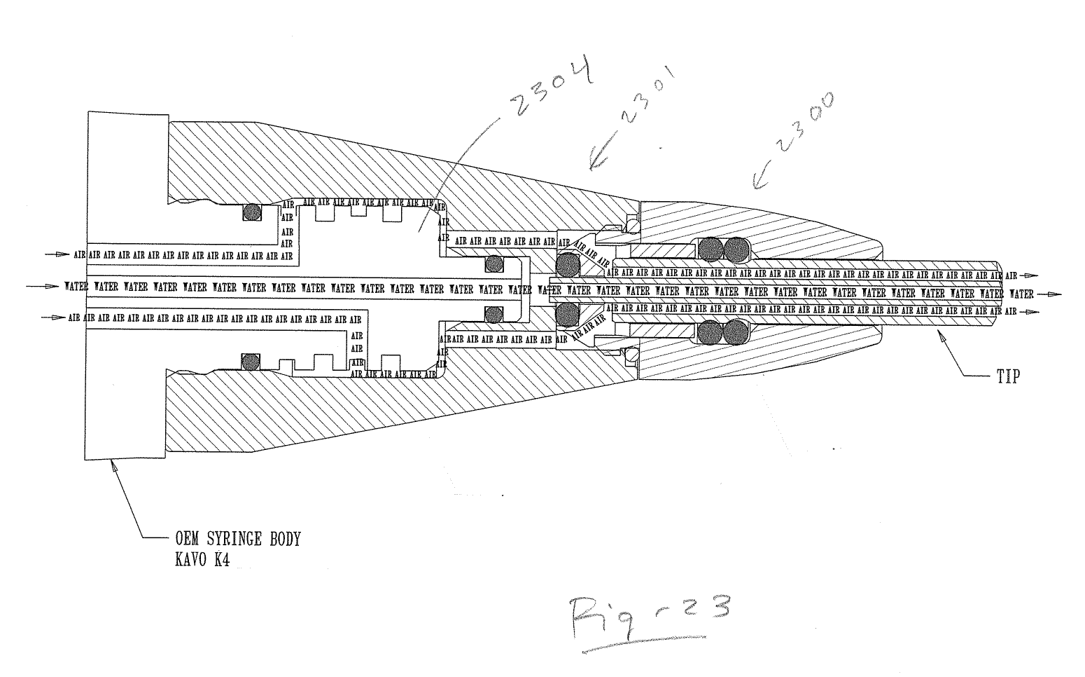

FIGS. 12 to 38 are detailed cross-sectional drawings that show particular adapter subassemblies and, in some cases, modified ferrules depending upon the design requirements. In these drawings, the existing syringe body is shown without cross-hatching, whereas the cap and adapter subassemblies are cross-hatched. Air and water flows are also illustrated with text in each cross section. All conversion kits further include multiple O-rings, depicted as black circles. In terms of materials, the ferrules are preferably constructed of a brass alloy to achieve demanding tolerances, whereas the other hard components may be constructed of aluminum or hard plastic. Although conversion kits having three or more components in addition to the O-rings, those of skill in the art will recognize that fewer pieces may be used through appropriate machining. For example, the ferrule and end cap may be formed of an integral unit by machining a single piece of brass or aluminum. While such fabrication may complicate the manufacturing process somewhat, the end result eliminates O-rings and simplifies assembly by the user.

While FIGS. 12 to 38 are well-understood and apparent to those of skill, comments will be made about incidental features and structures.

FIG. 12 is a cross section of a Castellini syringe body and conversion kit. Note in this case that since the syringe body 1202 expected to receive elongated air/water tubes from the removed tip, they are provided at 1204, 1206. The adapter subassembly 1201 also includes a component 1208 between the syringe body 1202 and ferrule 1210 coupled to the back of cap subassembly 1200.

The Cefla F3 LUZ syringe body and conversion kit of FIG. 13 includes an intermediate component 1302 in the adapter subassembly 1301 with slanted air/water channels and a stem 1304 that fits into the syringe body to replace the stem on the removed autoclavable tip. The cap subassembly is depicted at 1300.

FIG. 14 is a cross section of a Cefla F6 Anthos syringe body and a conversion kit which also includes a component 1402 in adapter subassembly 1401 providing a stem 1404 into the body of the syringe. The cap subassembly is shown at 1400.

The Chirana syringe body and conversion kit of FIG. 15 provides an anticipated threaded connection at 1502 with no prominent protrusions as with the tip being replaced. The radial air flow in this case is guided to the ferrule through a component 1504 forming part of the adapter subassembly. Note that in this case the cap subassembly 1500 extends all the way to the syringe body.

The Faro SM03 syringe body of FIG. 16 qualifies as a stem (1602) on the syringe system. Air is brought in from the side through adapter subassembly 1604. The cap subassembly is shown at 1600.

FIG. 17 is a cross section of a Faro SYR syringe body and a conversion kit. Although the replaced tip included an extension tube, 1702 of the adapter subassembly allows the extension 1704 of the tip itself to be used instead. The cap subassembly, shown at 1600, extends all the way to the syringe body 1701.

FIG. 18 is a cross section of a Kayo 1056 syringe body and a conversion kit. In this case the adapter subassembly 1802 includes two side passages for air flow to the ferrule and tip. The adapter subassembly 1802 is also configured to receive the stem 1804 on the syringe body. The cap subassembly is shown at 1800.

FIG. 19 is a cross section of a Kayo 1056S syringe body and a conversion kit. This includes a threaded connection 1902 without any prominent protrusions or tubes. The cap and adapter subassemblies are combined in this design at 1900. The ferrule is depicted at 1901.

The Kayo 6F syringe body of FIG. 20 also includes a stem 2104 received by the adapter subassembly 2102. The cap subassembly is shown at 2100.

FIG. 21 is a cross section of a Kayo Systematica (with light) syringe body and the conversion kit for that unit, which includes an adapter subassembly 2101 with a receptacle to receive the stem 2104 on the syringe body 2102. In this case, the water line 2106 is offset, but intermediate component 2108 of the adapter subassembly directs the water flow to the base of the ferrule and disposable tip. The cap subassembly is shown at 2100.

The Kayo Systematica (without light) syringe body of FIG. 22 is quite similar to the lighted version, as is the conversion kit. The adapter subassembly is shown at 2201 and the cap subassembly is shown at 2200.

FIG. 23 illustrates a conversion kit applicable to the Kayo K4 syringe. Note that in this and other embodiments of the invention, not all of the o-rings provided on the stem 2304 of the syringe are replaced once removed to receive the adapter and cap subassemblies. The adapter subassembly is shown at 2301 and the cap subassembly is shown at 2300.

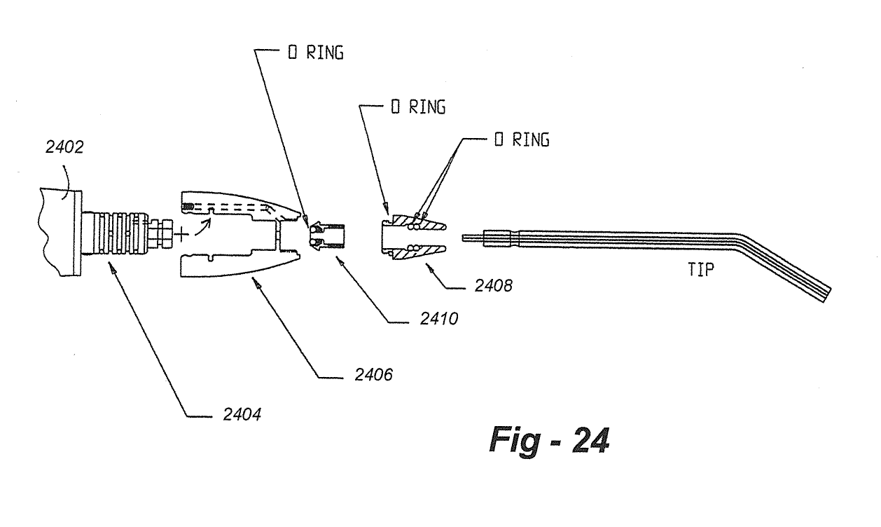

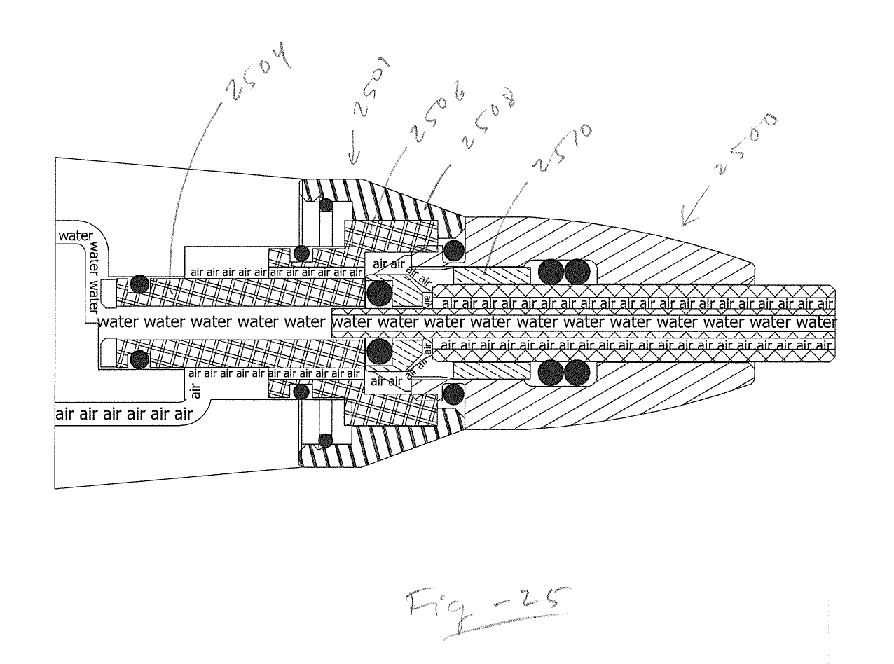

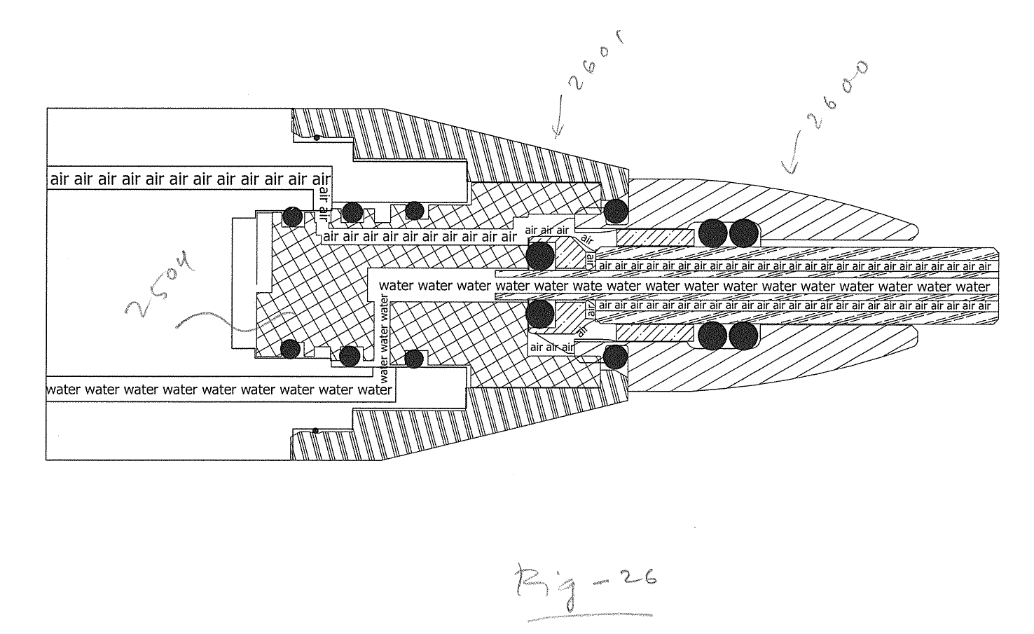

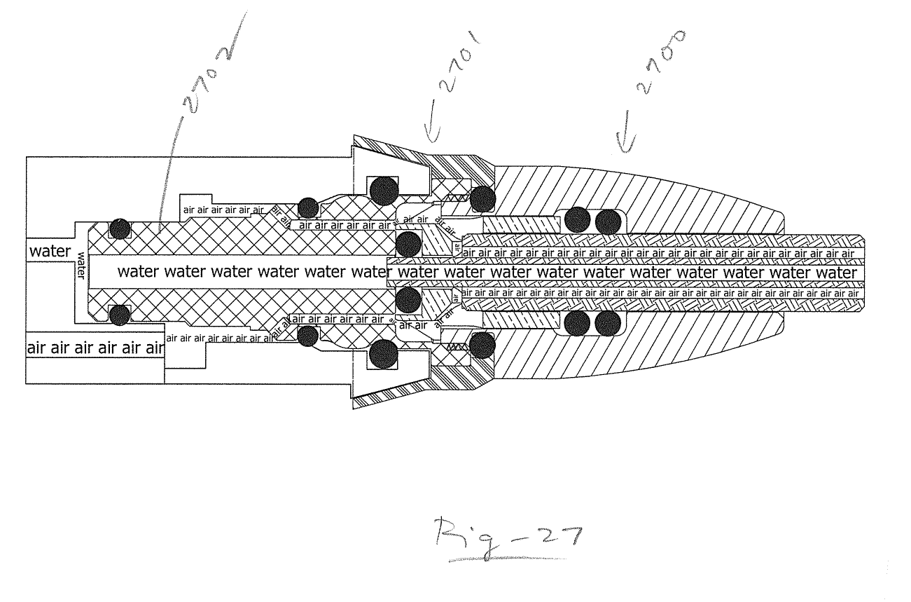

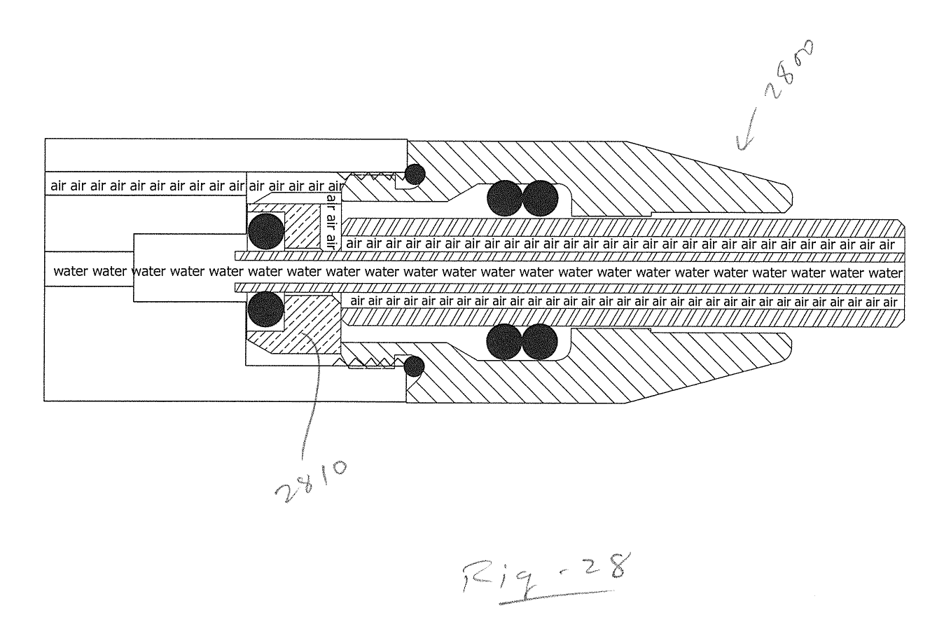

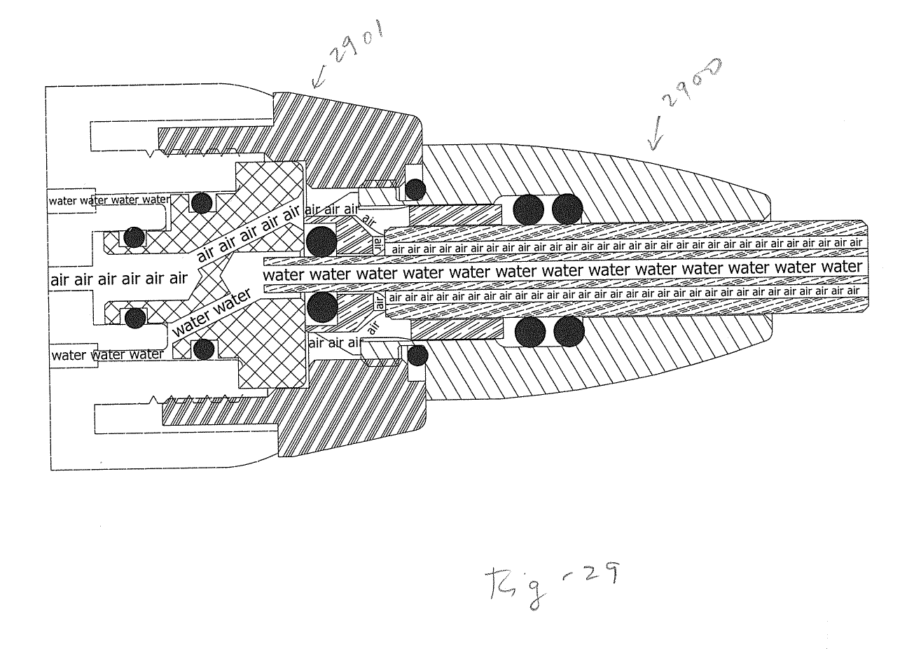

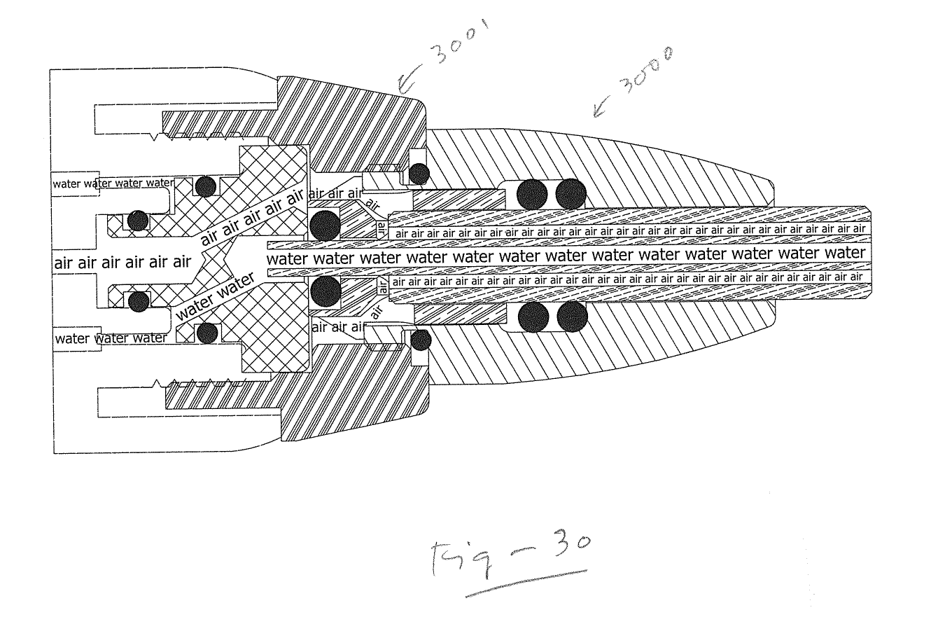

The Kayo Esthetica syringe body shown in FIG. 24 includes an elongated stem 2404 on the syringe body 2402, with air flowing out the side of the stem and into adapter subassembly 2406. Cap subassembly 2408 and ferrule 2410 cooperate to guide air and water to their respective destinations and shown in the Figure.

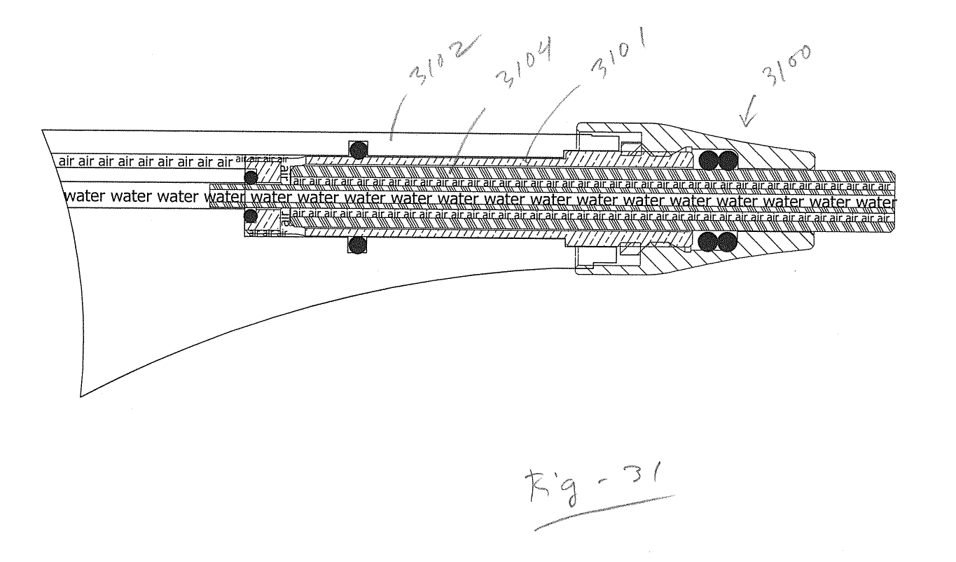

The Sirona 4000 is one of the stem-on-tip configurations. As shown in FIG. 25, multiple components 2504, 2506, 2508, 2510 in the adapted subassembly 2501 cooperate in this somewhat complex solution to air and water flow. The cap subassembly is depicted at 2500.

The Sirona C8 system of FIG. 26 is somewhat similar to the 4000 system of FIG. 25, with one exception being that both air and water are brought in through the sides of the stem 2504, as with the autoclavable tip that was replaced. The adapter subassembly is shown at 2601, and the cap subassembly at 2600.

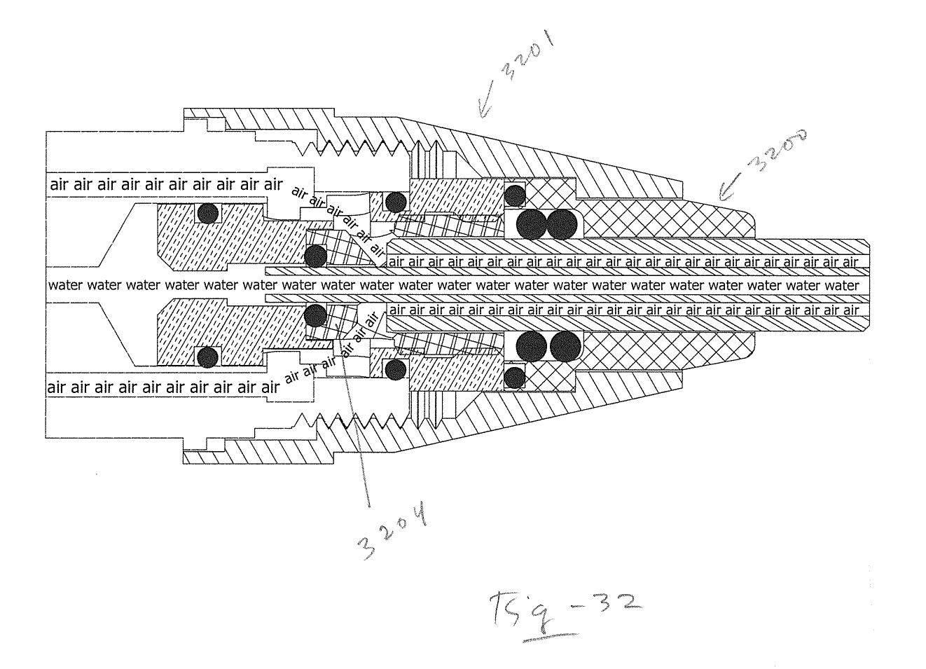

FIG. 27 is a cross section of a Ritter Topjet syringe body and a conversion kit, which includes an adapter subassembly with a somewhat elongated stem 2702 on the adapter subassembly 2701 to match the stem of the tip being replaced. Multiple components and O-rings are required, particularly with directing the air flow. The cap subassembly is called out at 2700.

Luzzani Mini Assistant syringe body and conversion kit of FIG. 28 is quite simple, with component 2810 comprising the adapted subassembly. The cap subassembly is shown at 2800. Note that this is a ferrule-less design.

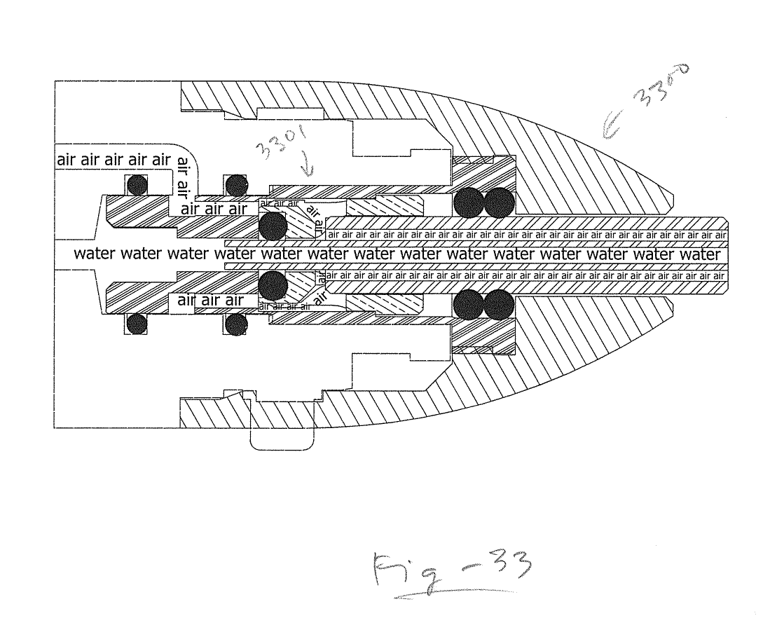

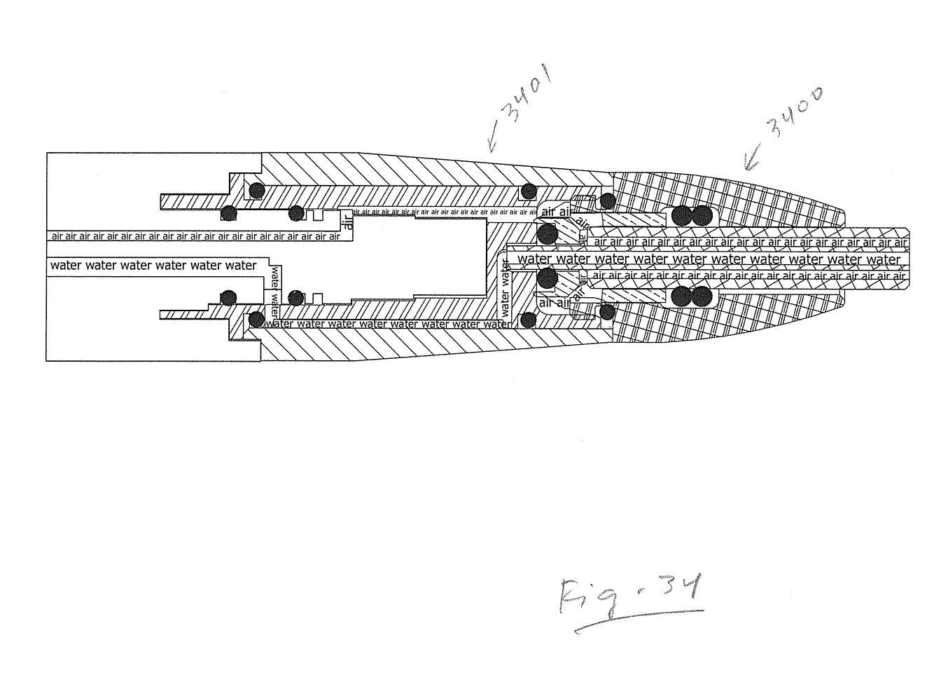

FIG. 29 is directed to the Luzzani Mini Mate syringe body and FIG. 30 is directed to the Luzzani Mini Light syringe body with associated conversion kit. The Luzzani Mini Light is very similar to the Mini Mate except that the Mini Light includes a light source. In this case, at least a portion of the disposable tip is constructed form a plastic such as Lucite which acts as a light pipe to conduct the illumination from the distal tip of the optical fiber to the distal end of the tip. As an alternative way to retain the illumination feature, the adapter subassembly may include along its length an optical fiber or solid light to conduct the illumination from the distal tip of the optical fiber to a light-emitting port disposed on the side of the adapter unit. The adapter subassemblies are shown at 2901, 3001 and the cap subassemblies at 2900, 3000.

FIG. 31 is a cross section of a Luzzani Mini Brite syringe body and conversion kit, which includes an adapter subassembly with an elongated stem 3104 that extends deep into the syringe body 3102. The cap subassembly is shown at 3100, and the cap subassembly, at 3101, amounts to an elongated ferrule.

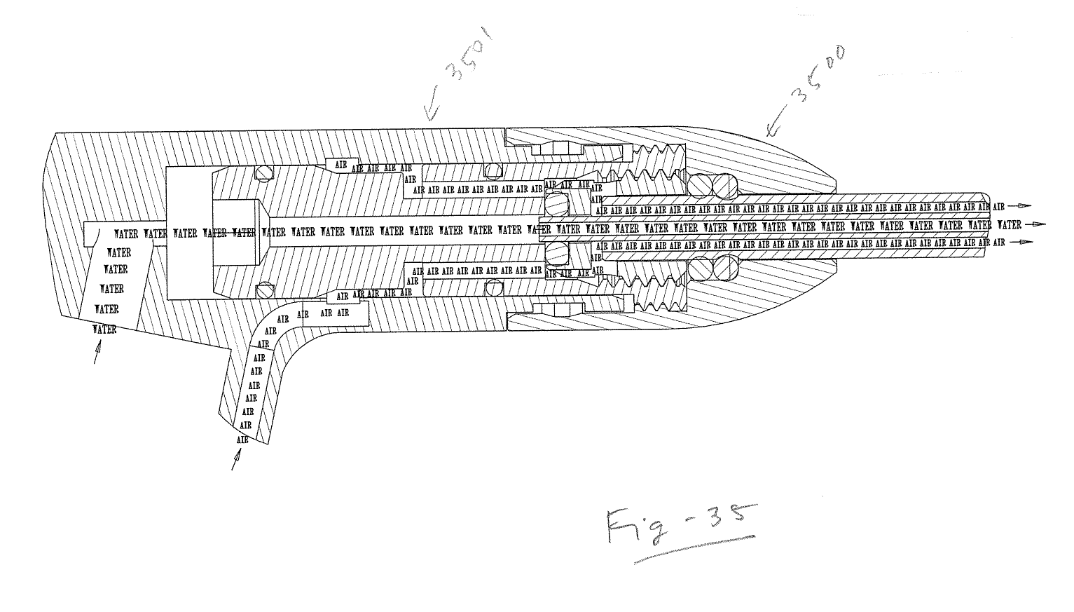

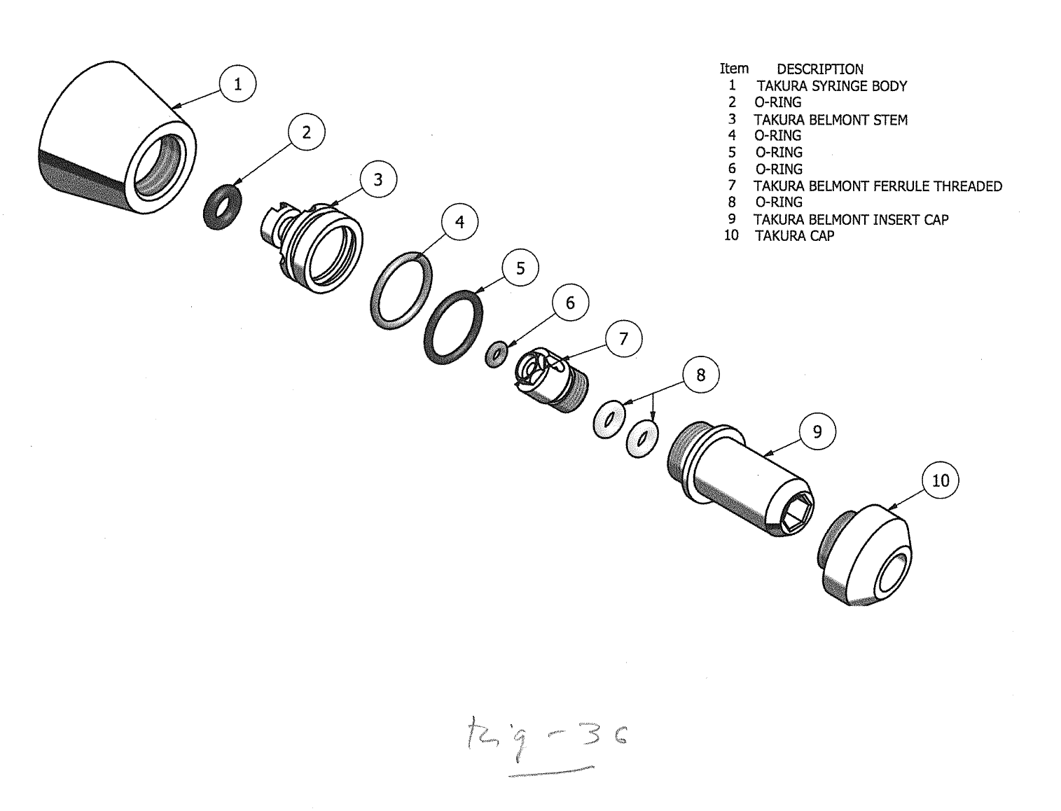

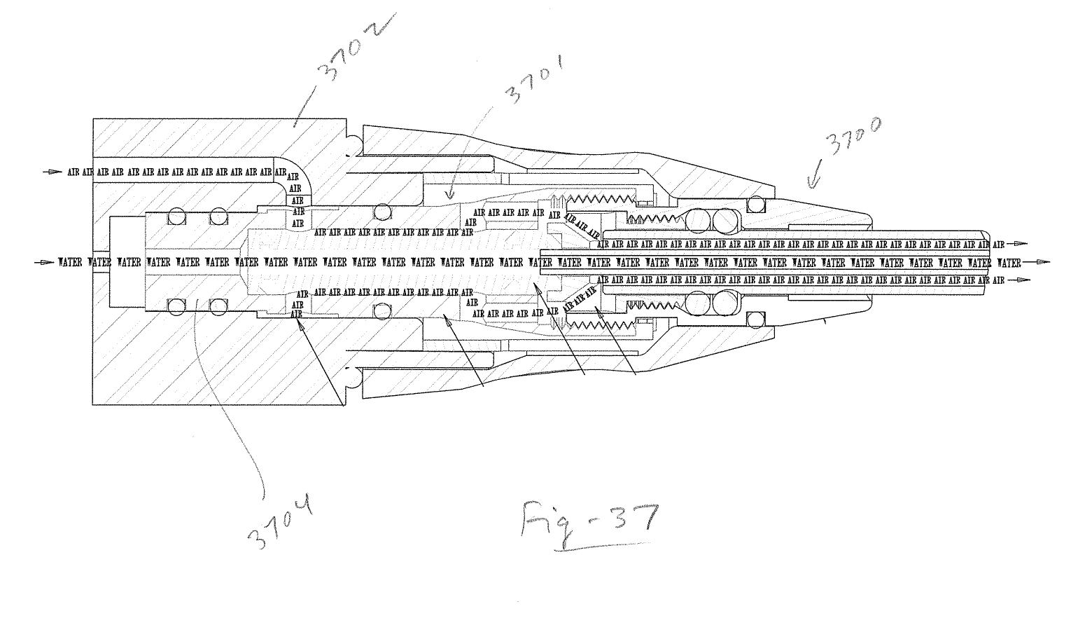

FIGS. 32 to 35 reside in conversion kits for Morita syringes. FIG. 32 concerns the Morita WS66; FIG. 33, the Morita WS97; FIG. 34, the Morita W10, and FIG. 35, the Morita Model 12. All of the conversion kits are quite complex, requiring multiple components and o-rings in the adapter subassemblies. Indeed, most of the designs require modified ferrules, some without a cup-shaped receptacle. The Morita 12 includes the entire upper portion of what would otherwise considered to be the syringe body.

In FIG. 32, the cap subassembly is shown at 3200, and the adapted subassembly is shown at 3201. In FIG. 33, the cap subassembly is shown at 3300, and the adapted subassembly is shown at 3301. In FIG. 34, the cap subassembly is shown at 3400, and the adapted subassembly is shown at 3401. In FIG. 35, the cap subassembly is shown at 3500, and the adapted subassembly is shown at 3501.

FIG. 36 is an exploded view of a Takara Belmont syringe body and conversion kit. In addition to the associated o-rings, the cap subassembly in this case includes items 9, 10, and the adapter subassembly includes component 3. The ferrule, threaded in this case, is shown at 7.

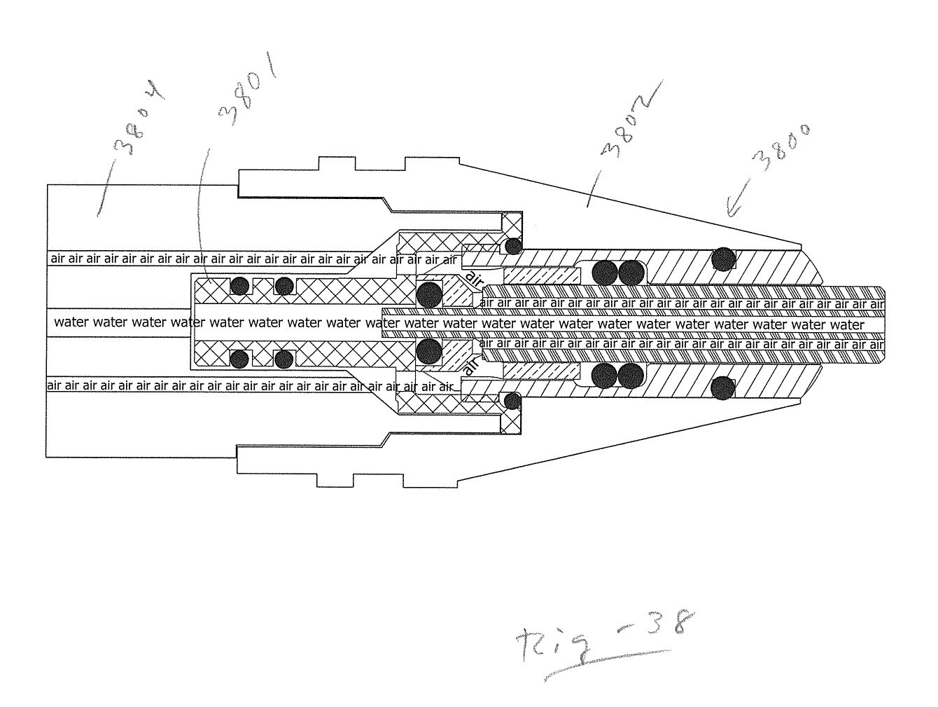

FIG. 37 is an exploded view of an Osada MSF syringe body and a conversion kit. Although quite different in overall design, both adapter subassemblies incorporate multiple components and threaded ferrules. The syringe body in FIG. 3702 is cross-hatched in this illustration. The adapter subassembly 3701 includes a stem with o-rings received by the syringe body. The cap subassembly 3700 is actually received by the adapter subassembly in this instance.

FIG. 38 is a cross section of a Tridac syringe body and a conversion kit enabling the syringe to accept disposable tips. The cap subassembly 3800 includes and outer cap body 3802 that is not cross-hatched. The adapted subassembly includes a stem 3801 that is received by the syringe body 3804.

I claim:

1. A conversion kit enabling an air/water syringe body configured to receive an autoclavable tip to instead receive an elongated, disposable tip having proximal and distal ends and a central, water-carrying tube surrounded by air-carrying channels, the kit comprising:
a cap subassembly including a cap body with a distal opening into which the proximal end of the elongated disposable tip is inserted; and
an adapter subassembly having a proximal end configured for connection to the syringe body and a distal end configured for coupling to the cap subassembly, the adapter subassembly including one or more components with cut-outs, grooves or channels to direct air and water from the syringe body to the air-carrying channels and water-carrying tube of the disposable tip through the cap subassembly.

2. The conversion kit of claim 1, wherein the adapter subassembly includes a proximal receptacle to receive a stem on the syringe body.

3. The conversion kit of claim 1, wherein the adapter subassembly includes a proximal stem insertable into the syringe body.

4. The conversion kit of claim 1, wherein the adapter subassembly includes one or more proximal proximal air- or water-carrying tubes insertable into the syringe body.

5. The conversion kit of claim 1, wherein the adapter subassembly includes a threaded connection to the syringe body.

6. The conversion kit of claim 1, further including a cup-shaped ferrule to receive the proximal end of the disposable tip once inserted into the cap subassembly.

7. The conversion kit of claim 1, further including a cup-shaped ferrule to receive the proximal end of the disposable tip, the ferrule including a central opening through which water passes into the water-carrying tube of the disposable tip and one or more side cut-outs through which air passes into the air-carrying channels of the disposable tip.

8. The conversion kit of claim 1, further including a cup-shaped ferrule with a central opening to receive a water-carrying tube extending from the proximal end of the disposable tip.

9. The conversion kit of claim 1, including a threaded connection between the cap and adapter subassemblies.

10. The conversion kit of claim 1, including a quick connect/disconnect connection between the cap and adapter subassemblies.

11. The conversion kit of claim 1, wherein the cap and adapter subassemblies are autoclavable in the absence of the disposable tip.

12. An adapter kit enabling a disposable tip to connect to a dental syringe that supplies air and water through separate air and water ports, the tip having a central, water-carrying tube surrounded by a plurality of air-carrying channels, the tip having a proximal base surface with openings to the air-carrying passages, with the water tube extending outwardly from the base surface, the kit comprising:
a cap subassembly including a cap body with a distal opening into which the proximal end of the elongated disposable tip is inserted; and
an adapter subassembly having a proximal end configured for connection to the syringe body and a distal end configured for coupling to the cap subassembly,
the adapter subassembly including an internal structure with a first path for coupling the water port of the syringe to the water-carrying tube of the tip through the cap subassembly, and a second path for coupling the air port of the syringe to the air-carrying channels of the disposable tip through the cap subassembly;
a receptacle having a bottom portion cooperating with the proximal base surface of the tip once inserted into the cap subassembly, the receptacle further including an aperture through which the water-carrying tube of the tip extends;
wherein a cavity is established between the bottom portion of the receptacle and the base surface of the tip; and
wherein the receptacle includes one or more side apertures through which air from the syringe passes into the cavity and into the air-carrying passages of the tip.

13. The adapter kit of claim 12, wherein the receptacle is a separate component coupled to the cap subassembly.

14. The conversion kit of claim 12, wherein the adapter subassembly includes a proximal receptacle to receive a stem on the syringe body.

15. The conversion kit of claim 12, wherein the adapter subassembly includes a proximal stem insertable into the syringe body.

16. The conversion kit of claim 12, wherein the adapter subassembly includes one or more proximal proximal air- or water-carrying tubes insertable into the syringe body.

17. The conversion kit of claim 12, wherein the adapter subassembly includes a threaded connection to the syringe body.

18. The conversion kit of claim 12, including a threaded connection between the cap and adapter subassemblies.

19. The conversion kit of claim 12, including a quick connect/disconnect connection between the cap and adapter subassemblies.

20. The conversion kit of claim 12, wherein the cap and adapter subassemblies are autoclavable in the absence of the disposable tip.

21. A method enabling a dental syringe having an existing tip to instead receive a disposable tip having a central, water-carrying tube surrounded by a plurality of air-carrying channels, comprises the steps of:
removing the existing tip from the syringe;
coupling conversion assembly to the syringe, the assembly having proximal end adapted for connection to the syringe in place of the existing tip, and a distal end with an opening to receive the proximal end of a disposable tip, the conversion unit including an internal structure with a first path for coupling the water port of the syringe to the water-carrying tube of the tip and a second path for coupling the air port of the syringe to the air-carrying channels of the tip; and
inserting the proximal end of the tip into the distal end of the adapter such that water is able to flow from the syringe through the water-carrying tube of the disposable tip, and air from the syringe is able to flow from the syringe through the air-carrying channels of the disposable tip.

22. The method of claim 21, wherein the conversion assembly includes a proximal adapter subassembly connected to a separate, distal cap subassembly.

23. The method of claim 21, including the step of providing a conversion assembly with a proximal receptacle to receive a stem on the syringe.

24. The method of claim 21, including the step of providing a conversion assembly with a proximal stem insertable into the syringe.

25. The method of claim 21, including the step of providing a conversion assembly with one or more proximal proximal air- or water-carrying tubes insertable into the syringe.

26. The method of claim 21, including the step of provided a conversion assembly threaded connection to the syringe.
